(19) United States
(12) Patent Application Publication
(10) Pub. No.: US 2025/0385459 A1
(43) Pub. Date: Dec. 18, 2025

(54) ELECTRICAL CONNECTOR ASSEMBLY

(71) Applicant: Anderson Power Products, Inc., Sterling, MA (US)

(72) Inventor: Isabel Gervais, Lowell, MA (US)

(21) Appl. No.: 18/747,107

(22) Filed: Jun. 18, 2024

(51) Int. Cl. H01R 13/40; H01R 13/627; H01R 24/60; H01R 43/20

(52) U.S. Cl. CPC H01R 13/40; H01R 13/6273; H01R 24/60; H01R 43/20

(57) ABSTRACT

An electrical connector assembly is provided, including a mounting plate with mounting geometry configured to mate with an electrical connector, the mounting plate also having a plurality of fastener apertures configured in a pattern. The assembly also includes a connector housing configured to secure the electrical connector, the connector housing including a first surface defining a second plurality of fastener apertures configured in the pattern; a second surface defining a third plurality of fastener apertures configured in the pattern; and a slot shaped to receive the mounting plate and to hold the mounting plate in a substantially fixed position in which the first plurality of fastener apertures aligns with one or both of the second plurality of fastener apertures or the third plurality of fastener apertures.

### BACKGROUND

Connectors capable of electrically connecting one or more electrically conductive elements are used to complete electrical circuits in various wiring applications. Single and multiple contact electrical connector systems are widely used for many household and industrial applications. Connectors may be used to connect a power source to a current-carrying electrically conductive element; to connect two electrically conductive elements together; or to connect several different devices which utilize electrical energy to an electrical circuit. Connectors are configured in many different form factors, and different connectors have different arrangements of electrically conductive elements within their connection interface.

Typically, such connector systems include a plug and a compatible receptacle, each of which includes or can accept installation of one or more electrical contacts that are connected to each other when the plug is mated with the receptacle. Plug and receptacle housings are provided so as to isolate the electrical contacts, position them in alignment with each other, and maintain the contacts in secure connection with each other when the connectors are mated. The contacts may be integral with the housings, or they may be installable into the housings, so that a given housing system can accept a plurality of types and arrangements of contacts. A latch mechanism may be included with the housings so as to avoid inadvertent separation of the plug from the receptacle.

### BRIEF DESCRIPTION OF DRAWINGS

FIG. 1 is a front perspective exploded view of an example first connector assembly.

FIG. 2 is a front perspective exploded view of an example second connector assembly.

FIGS. 3 and 4 are top and bottom perspective views, respectively, of a mounting plate of the first connector assembly of FIG. 1.

FIG. 5 is a top view of the mounting plate of FIGS. 3 and 4.

FIG. 6 is a side view of the mounting plate of FIGS. 3 and 4.

FIG. 7 is a bottom view of the mounting plate of FIGS. 3 and 4.

FIG. 8 is a front perspective view of an example connector that may find use with the connector assemblies of the present disclosure.

FIG. 9 is a top view of the connector of FIG. 8.

FIG. 10 is a front perspective view of an example connector that may find use with the connector assemblies of the present disclosure.

FIG. 11 is a top view of the connector of FIG. 10.

FIGS. 12 and 13 are top and bottom perspective views, respectively, of a mounting plate of the second connector assembly of FIG. 2.

FIG. 14 is a top view of the mounting plate of FIGS. 12 and 13.

FIG. 15 is a side view of the mounting plate of FIGS. 12 and 13.

FIG. 16 is a bottom view of the mounting plate of FIGS. 12 and 13.

FIG. 17 is a front perspective view of an example connector that may find use with the connector assemblies of the present disclosure.

FIG. 18 is a top view of the connector of FIG. 17.

FIG. 19 is a front perspective view of an example connector that may find use with the connector assemblies of the present disclosure.

FIG. 20 is a top view of the connector of FIG. 19.

FIG. 21 is a top view of the connector housing of the connector assembly of FIG. 1.

FIG. 22 is a bottom view of the connector housing of the connector assembly of FIG. 1.

FIG. 23 is a front view of the connector housing of the connector assembly of FIG. 1.

FIG. 24 is a top view of the connector housing of the connector assembly of FIG. 2.

FIG. 25 is a bottom view of the connector housing of the connector assembly of FIG. 2.

FIG. 26 is a front view of the connector housing of the connector assembly of FIG. 2.

FIG. 27 is a side cross-sectional view of the connector housing of FIGS. 21-23, taken along line A-A in FIG. 21.

FIG. 28 is a side cross-sectional view of the connector housing of FIGS. 24-26, taken along line B-B in FIG. 24.

FIG. 29 illustrates assembly of the connector assembly of FIG. 1.

FIG. 30 is a illustrates assembly of the connector assembly of FIG. 2.

FIG. 31 is a top view of a connector housing.

FIG. 32 is an overall perspective view of the connector housing of FIG. 31.

FIG. 33 is a front view of the connector housing of FIG. 31.

FIG. 34 is a section view of the connector housing of FIG. 31, taken along line C-C of FIG. 31.

FIG. 35 is a flow chart illustrating an example method for assembling a connector assembly

### DETAILED DESCRIPTION

Multiple electrical connectors may be used together to provide a total number of electrical connections that is larger than any of the connectors individually. Often, the two or more electrical connectors used together are not fastened to each other before installation. This may present difficulties in the configuration and connection portions of assembly. Additional time may be needed to find the corresponding plug and receptacle geometry for each electrical connector pair; and additional time may be needed for the operator to connect the plug and receiver of each electrical connector type. Each electrical connector type may be able to move independently of the other electrical connector type, which may negatively affect the integrity and stability of the total electrical application, as the different electrical connectors may be able to pull apart from each other during application and may further become entangled with one another during application.

Consequently, an improved connector housing assembly may be provided to secure electrical connectors of varying types to one another for simpler, more reliable connections. A connector housing assembly may securely fasten a first electrical connector pair to a second electrical connector pair and may accommodate electrical connector types in a number or plurality of different designs or types. By providing an apparatus or device and a method for fastening multiple different electrical connector pairs together in a variety of different configurations, a modular system capable of providing a larger capacity of possible electrical contacts and connections is achieved.

Described herein are connector assemblies for providing multiple electrical connectors in a single housing. Using such assembles, a four-wire, five-wire, or other multi-wire connector may be assembled using two connectors of a smaller wire quantities in a single housing.

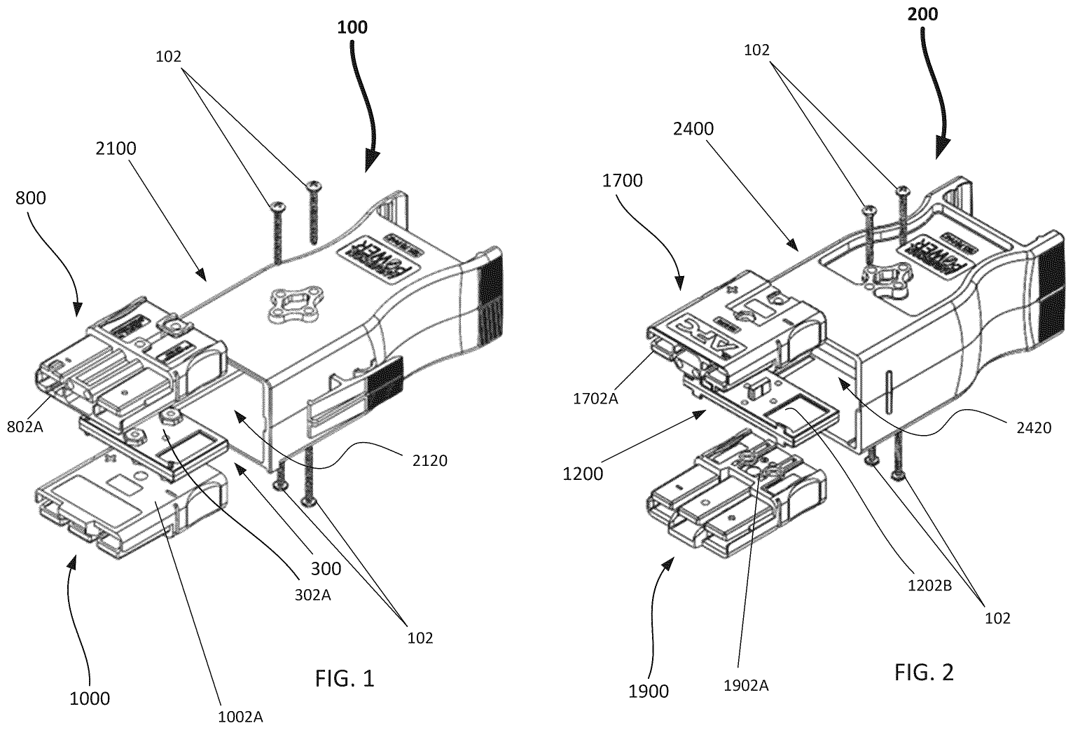

Referring now to the drawings, wherein like reference numerals are used to identify identical or similar components in the various views, FIG. 1 illustrates a first connector assembly 100 including a plug housing 2100, a mounting plate 300, and two electrical connectors, one of a plug (first) type 800 and one of a receptacle (second) type 1000. The mounting plate 300 is configured to receive a first side 802A of the first connector 800 on a first side of the mounting plate 302A and a first side 1002A of the second connector 1000 on a second side of the mounting plate 302B. Fasteners 102 may secure the mounting plate and the connectors within the housing 2100.

FIG. 2 illustrates a second connector assembly 200 including a receptacle housing 2400, a mounting plate 1200, and two electrical connectors, one of a plug (first) type 1900 and one of a receptacle (second) type 1700. The mounting plate 1200 is configured to receive a first side 1902A of the first connector 1900 on a first side of the mounting plate 1202A and a first side 1702A of the second connector 1700 on a second side of the mounting plate 1202B. Fasteners 102 may secure the mounting plate and the connectors within the housing 2400.

The connector assemblies are assembled in a similar fashion to each other. The plug connector 800, 1900 is placed on the first side 302A, 1202A of the mounting plate 300, 1200 and the receptacle connector 1000, 1700 is placed on the second side 302B, 1202B of the mounting plate, with geometry of the mounting plate mating with geometry of each connector, as described below. The mounting plate, with first and second connectors coupled, may then be inserted into the plug/receptacle housing 2100, 2400, and fasteners 102 may be used to secure the connectors and mounting plate within the housing 2100, 2400.

The plug (first) connector 800 of the first assembly may mate with the receptacle (second) connector 1700 of the second assembly, and the receptacle (second) connector 1000 of the first assembly may mate with the plug (first) connector 1900 of the second assembly.

Accordingly, when the first connector assembly is assembled and the second connector assembly is assembled, the first connector assembly 100 may mate with the second connector assembly 200.

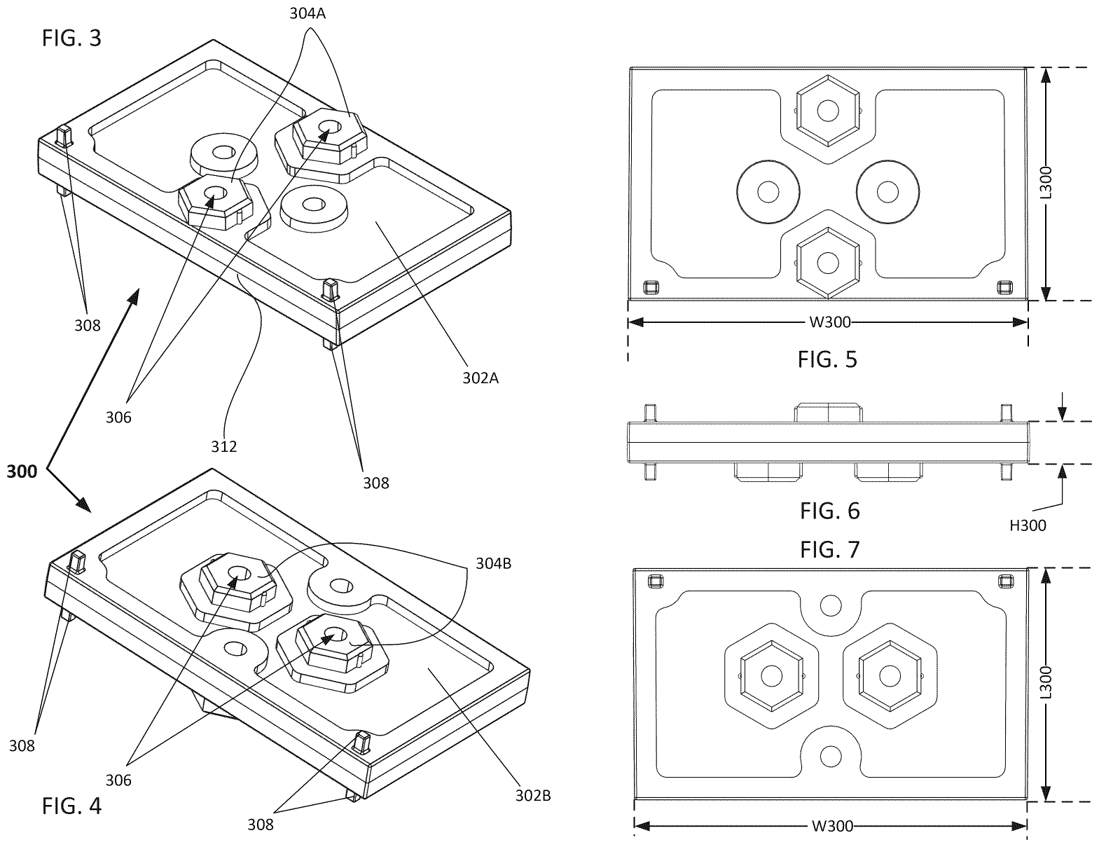

FIGS. 3-7 illustrate the mounting plate 300 in greater detail. The mounting plate 300 includes a mounting geometry 304A, 304B on either or both sides of the mounting plate 302A, 302B. The mounting geometry 304 may further define at least one protrusion or at least one recess, and in some embodiments may include a plurality of protrusions, or a plurality of recesses, and in some embodiments may include a combination of at least one protrusion and at least one recess. For example, on a first side of the mounting plate 302A, in some embodiments a protrusion 304 may be in the shape of a hexagon with a uniform height. The first side of the mounting plate 302A contains two hexagon shaped protrusions 304A which are at the same position along the width W300 of the mounting plate and spaced along the length L300 of the mounting plate. The spacing along the length L300 of the mounting plate corresponds to the spacing of two hexagon shaped recesses located on the first side of the first electrical connector of the first assembly. On the other or second side 302B of the mounting plate 300, in some embodiments, the mounting plate 300 contains two hexagon shaped protrusions 304B which are at the same position along the length L300 of the mounting plate and spaced along the width W300 of the mounting plate 300. The spacing along the width W300 of the mounting plate corresponds to the spacing of two hexagon shaped recesses located on the first side of the second electrical connector of the first assembly.

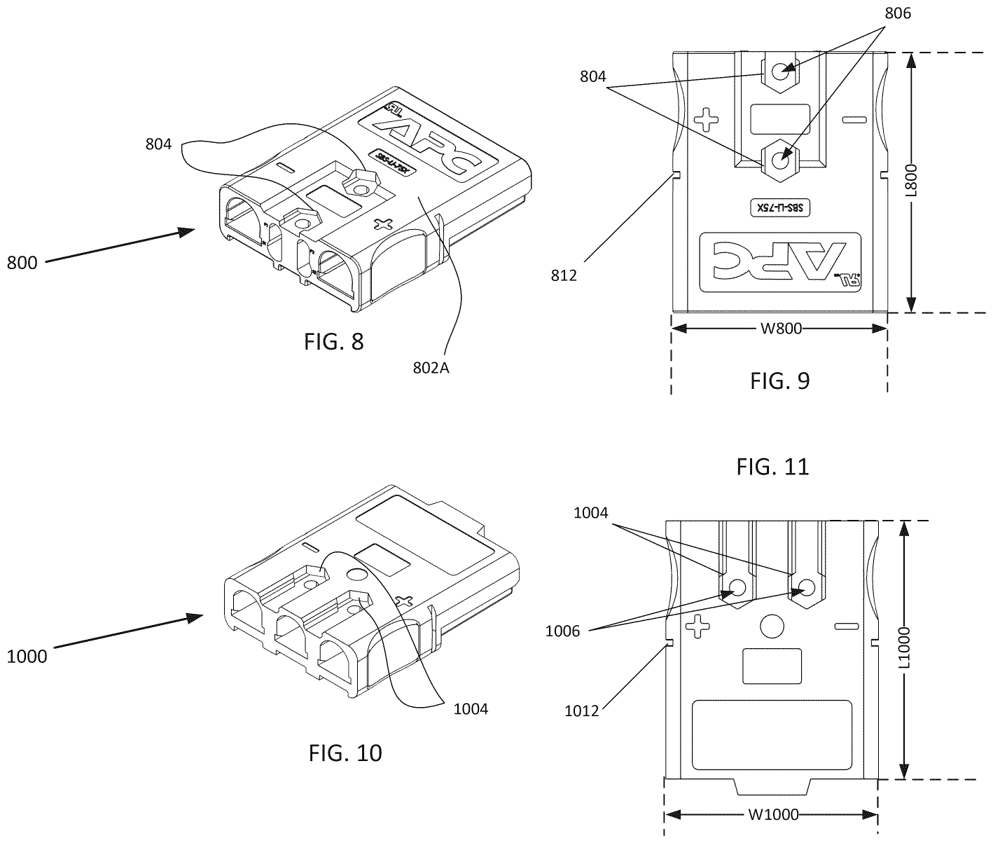

FIGS. 8 and 9 illustrate the first connector 800 of the first assembly 100 in detail, and FIGS. 10 and 11 illustrate the second connector 1000 of the first assembly 100 in detail. The first connector 800 may include one or more (e.g., a plurality, such as two) recesses 804 that may mate with the protrusions on the first side of the mounting plate. The recesses 804 on the first connector 800 may be located at the same position along the width W800 of the connector 800 and spaced along the length L800 of the connector 800 at the same spacing as the protrusions located on the first side of the mounting plate. Similarly, the second connector 1000 may include one or more (e.g., a plurality, such as two) recesses 1004 that may mate with the protrusions on the second side of the mounting plate. The recesses 1004 on the second connector 1000 may be located at the same position along the length L1000 of the connector 1000 and spaced along the width W1000 of the connector 1000 at the same spacing as the protrusions located on the second side of the mounting plate. The recesses 804, 1004 of the connectors 800, 1000 may have the same or substantially similar shapes (e.g., hexagons) to the corresponding protrusions on the mounting plate.

Shown in FIG. 1, The mounting plate protrusions 304 may fit into and/or be coupled to the connector recesses 804, 1004 by friction fit, press fit, sliding fit, adhesive, fastener, and/or by any other mechanical or chemical means to substantially affix the connectors 800, 1000 to the mounting plate 300 in an orientation. In the example embodiment shown, the hexagonal shape of the protrusions 304 constrains the motion of the connectors 800, 1000 by preventing the connectors from sliding or transverse movement across the mounting plate 300 and by preventing the connectors 800, 1000 from rotation on the surface of the mounting plate 300.

The configuration of protrusions and/or recesses on the mounting plate may serve as keying geometry, or geometry which fixes and constrains the connectors in an orientation and prevents movement of the connectors in any one or all directions. By constraining the connectors on the mounting plate, the connectors may further be placed into the connector housing assembly in a correct orientation and alignment, and thus may further be assembled into the electrical application in a correct orientation and alignment, in combination with other elements of the electrical housing assembly, without further alignment efforts by an operator.

Referring to FIGS. 8-11, the connectors 800, 1000 may each further have at least one fastener aperture 806, 1006. In the example embodiment, each connector 800, 1000 includes two fastener apertures 806, 1006, arranged in a pattern, which in the example embodiment are located within the recesses 804, 1004. Shown in FIGS. 3-7, the mounting plate 300 similarly includes two fastener apertures 306 arranged in a pattern, within the protrusions 304 on either side of the mounting plate 302A, 302B which align with and correspond to the two fastener apertures on the connectors such that a fastener may be driven through the apertures to secure the connectors to the mounting plate.

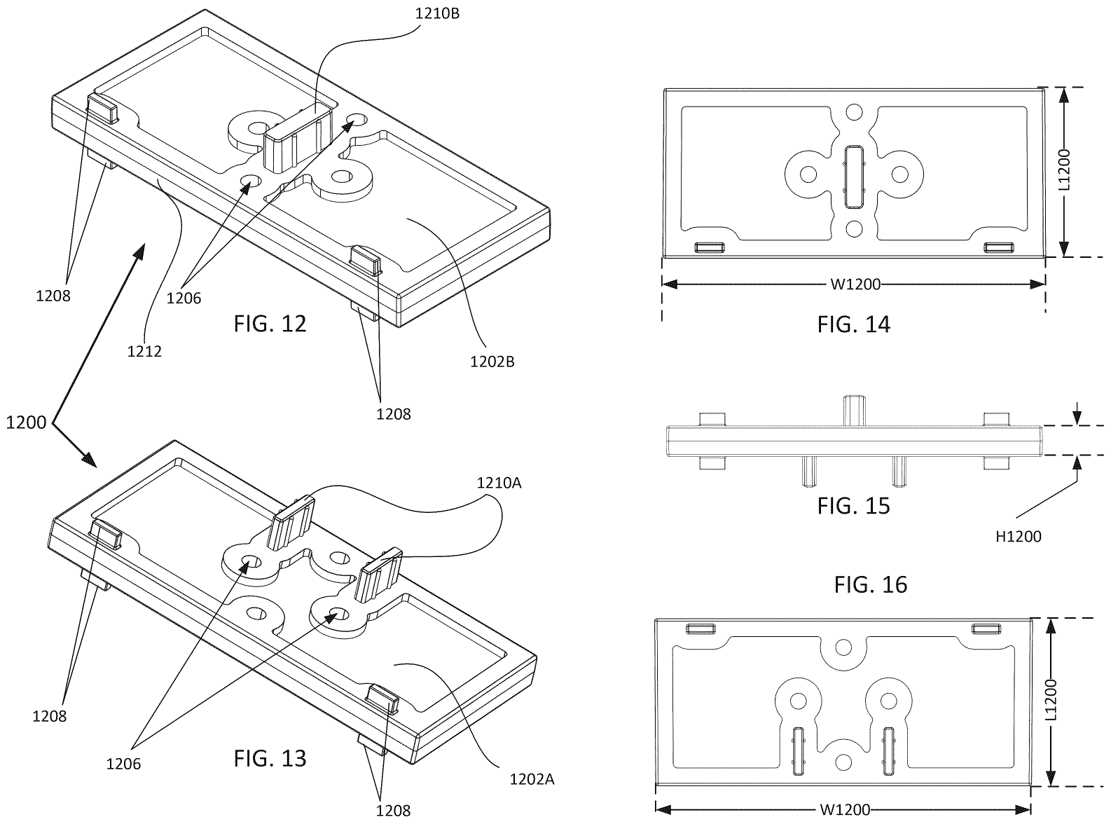

FIGS. 12-16 illustrate the mounting plate 1200 in greater detail. The mounting plate 1200 includes a mounting geometry 1210A, 1210B on either or both sides of the mounting plate 1202A, 1202B. The mounting geometry 1210 may further define at least one protrusion or at least one recess, and in some embodiments may include a plurality of protrusions, or a plurality of recesses, and in some embodiments may include a combination of at least one protrusion and at least one recess. For example, on a first side of the mounting plate 1202A, in some embodiments a protrusions 1210 may be in the shape of a rectangle with a uniform height. The first side of the mounting plate 1202A contains two rectangle shaped protrusions 1210A which are at a fixed position along the length L1200 of the mounting plate 1200 and spaced along the width W1200 of the mounting plate 1200. The position along the length L1200 and spacing along with W1200 of the mounting plate 1200 corresponds to the location of the rectangular shaped recesses located on the first side of the first connector of the second assembly. On the other or second side 1202B of the mounting plate 1200, in some embodiments, the mounting plate 1200 contains one rectangular shaped protrusion 1210B which is at a fixed position along the length L1200 and width W1200 of the mounting plate 1200. The position along the length L1200 and width W1200 of the mounting plate 1200 corresponds to the location of the rectangular shaped recess located on the first side of the second connector of the second assembly.

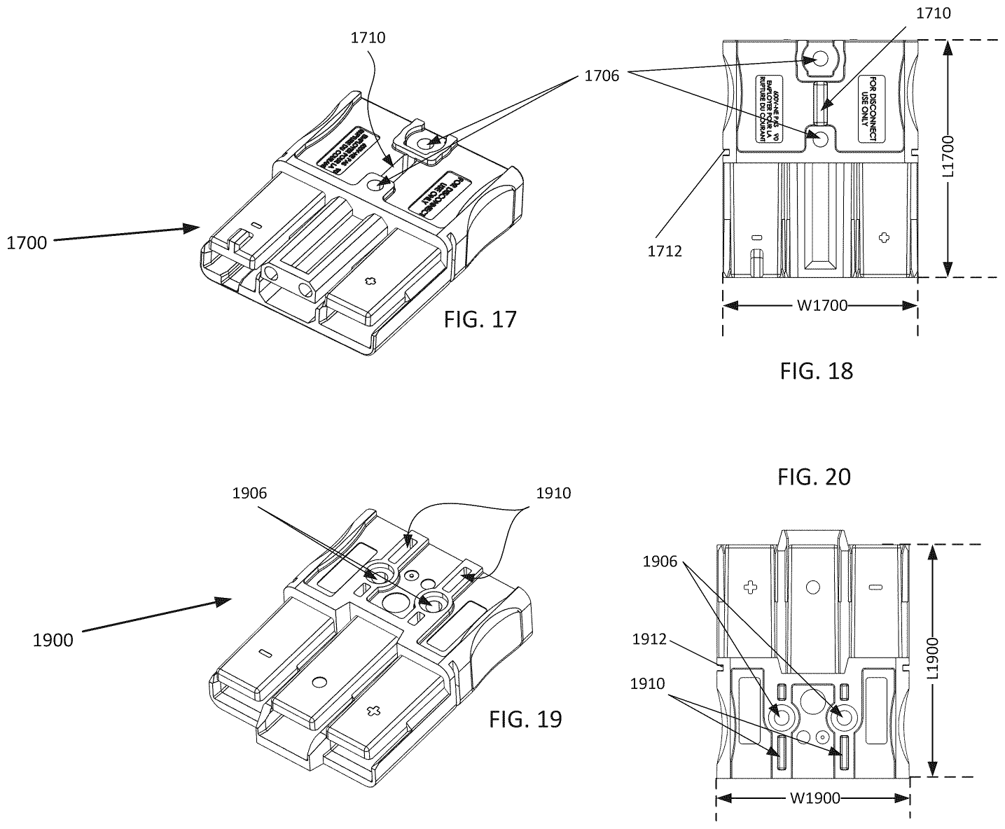

FIGS. 17 and 18 illustrate the second connector 1700 of the second assembly in detail, and FIGS. 19 and 20 illustrate the first connector 1900 of the second assembly in detail. The first connector 1900 may include one or more (e.g., a plurality, such as two) recesses 1910 that may mate with the protrusions on the first side of the mounting plate. The recesses 1910 on the first connector 1900 may be located at the same position along the length L1900 and spaced along the width W1900 of the connector 1900 at the same spacing as the protrusions located on the first side of the mounting plate. Similarly, the second connector 1700 may include one or more (e.g., a plurality, such as two) recesses 1710 that may mate with the protrusion on the second side of the mounting plate. The recess 1710 on the second connector 1700 may be located at the same position along the length L1700 and width W1700 of the connector 1700 at the same spacing as the protrusions located on the second side of the mounting plate. The recesses 1710, 1910 of the connectors may have the same or substantially similar shapes (e.g., rectangles) to the corresponding protrusions on the mounting plate.

Shown in FIG. 2, the mounting plate protrusions 1210A, 1210B may fit into and/or be coupled to the connector recesses 1710, 1910 by friction fit, press fit, sliding fit, adhesive, fastener, and/or by any other mechanical or chemical means to substantially affix the connectors 1700, 1900 to the mounting plate 1200 in an orientation. In the example embodiment shown, the rectangular shape of the protrusions 1210 constrains the motion of the connectors 1700, 1900 by preventing the connectors from sliding or transverse movement across the mounting plate 1200 and by preventing the connectors from rotation on the surface of the mounting plate.

The configuration of protrusions and/or recesses on the mounting plate may serve as keying geometry, or geometry which fixes and constrains the connectors in an orientation and prevents movement of the connectors in any one or all directions. By constraining the connectors on the mounting plate, the connectors may further be placed into the connector housing assembly in a correct orientation and alignment, and thus may further be assembled into the electrical application in a correct orientation and alignment, in combination with other elements of the electrical housing assembly, without further alignment efforts by an operator.

Referring to FIGS. 17-20, the connectors 1700, 1900 may each further have at least one fastener aperture 1706, 1906. In the example embodiment, each connector 1700, 1900 includes two fastener apertures 1706, 1906 arranged in a pattern. Referring to FIGS. 12-16, the mounting plate 1200 similarly includes two fastener apertures 1206 arranged in a pattern, on either side of the mounting plate 1200 which align with and correspond to the two fastener apertures 1706, 1906 on the connectors 1700, 1900 such that a fastener may be driven through the apertures to secure the connectors to the mounting plate.

Referring to FIGS. 1-2, in some embodiments, the plug (first) connector 800 of the first assembly 100 may be inverted, or rotated 180 degrees about the width of the connector, to become the receptacle (second) connector 1700 of the second assembly. The receptacle (second) connector 1000 of the first assembly 100 may be inverted, or rotated 180 degrees about the width of the connector, to become the plug (first) connector 1900 of the second assembly 200. That is, the geometry of a mating end of a connector may be such that the same connector may be used as a plug and a receptacle, wherein the end of a connector can mate with the same end of an identical connector that is inverted. This may be true for either or both the first and second connectors of both the first and second assemblies. In this embodiment, the connector may have a first side having a first geometry and a second side having a second geometry. The first assembly may comprise a first mounting plate having mounting geometry corresponding to the geometry of the first side of the connector. The second assembly may comprise a second mounting plate having mounting geometry corresponding to the geometry of the second side of the connector. One of the connectors may be mounted on the first mounting plate on the first side of the connector. Another of the connectors may be mounted on the second mounting plate on the second side of the connector. In this manner, the first assembly having the connector mounted on the first side (plug side) may mate with the second assembly having the connector mounted on the second side (receptacle side).

The mounting plate may further contain additional or alternative mounting geometry on both the first and second sides of the mounting plate. Additional mounting geometry may include clip and retention features which may attach to an electrical connector of a first type or electrical connector of a second type; pin and detent features which may fit into a detent or pin of an electrical connector of a first type or electrical connector of a second type; adhesive features which may chemically or physically fix an electrical connector of a first type or an electrical connector of a second type to the surface of the mounting plate. All physical and chemical features of the mounting plate may constrain or otherwise fix an electrical connector of any type to the mounting plate and operate in the same manner to achieve the same result of constraining an electrical connector in a fixed orientation and alignment to a side of the mounting plate.

Referring to FIGS. 3-7 and 12-16, each mounting plate 300, 1200 may further contain assembly protrusions 308, 1208 located along one leading edge, or terminal side 312, 1212 of the mounting plate 300, 1200. The assembly protrusions 308, 1208 may serve one or more functions. The assembly protrusions 308, 1208 may indicate which edge of the mounting plate 300, 1200 should face out (i.e. the terminal side 312, 1212) when installed into a connector housing 2100, 2400, as pictured in FIGS. 1-2. The assembly protrusions 308, 1208 may also interfere with the electrical connectors of a first and second type 800, 1000, 1700, 1900, if they are improperly placed on the mounting plate 300, 1200, such that, when the electrical connectors of a first and second type are properly installed, the assembly protrusions fit into a gap or slot 812, 1012, 1712, 1912 on the electrical connectors of a first or second type 800, 1000, 1700, 1900. Thus, the assembly protrusions 308, 1208 prevent the electrical connectors of a first or second type from being installed in a wrong direction (i.e., backwards) on the mounting plate 300, 1200.

Although specific embodiments have been disclosed for mounting geometries in the above example embodiments, it should be known that other mounting geometries, other shapes, such as triangles, squares, circles, and other combinations of corresponding protrusions and recesses on the electrical connectors and the mounting plates may be used to accomplish substantially the same result, in substantially the same manner. Likewise, although in the above disclosed embodiments, the plug connector has a different outer surface geometry or mounting geometry than the receptacle connector, in some embodiments, the electrical connectors of a first and second type may have the same outer surface geometry or mounting geometry. In those embodiments, the first and second sides of the mounting plate may have the same mounting geometries.

In some embodiments, when the electrical connectors are flipped or inverted, the electrical connectors may have the same mounting geometry on the first side as the electrical connectors on the second side, i.e., a mounting plate geometry for a plug side connector may be the same as the mounting plate geometry for a receptacle side geometry. It should be known that any combination of mounting geometries on a first side of a mounting plate and mounting geometries on a second side of a mounting plate will accomplish substantially the same result in substantially the same manner.

The mounting plate may be made from any material currently used in the field of the art, including but not limited to plastics, composite, organic, metal alloys, or the like. The mounting plate may also be manufactured using methods currently used in the art, including but not limited to machining, molding, injection molding, casting, or the like. All materials and methods of manufacturing will accomplish the same functionality of the mounting plate in much the same manner, to achieve the same result.

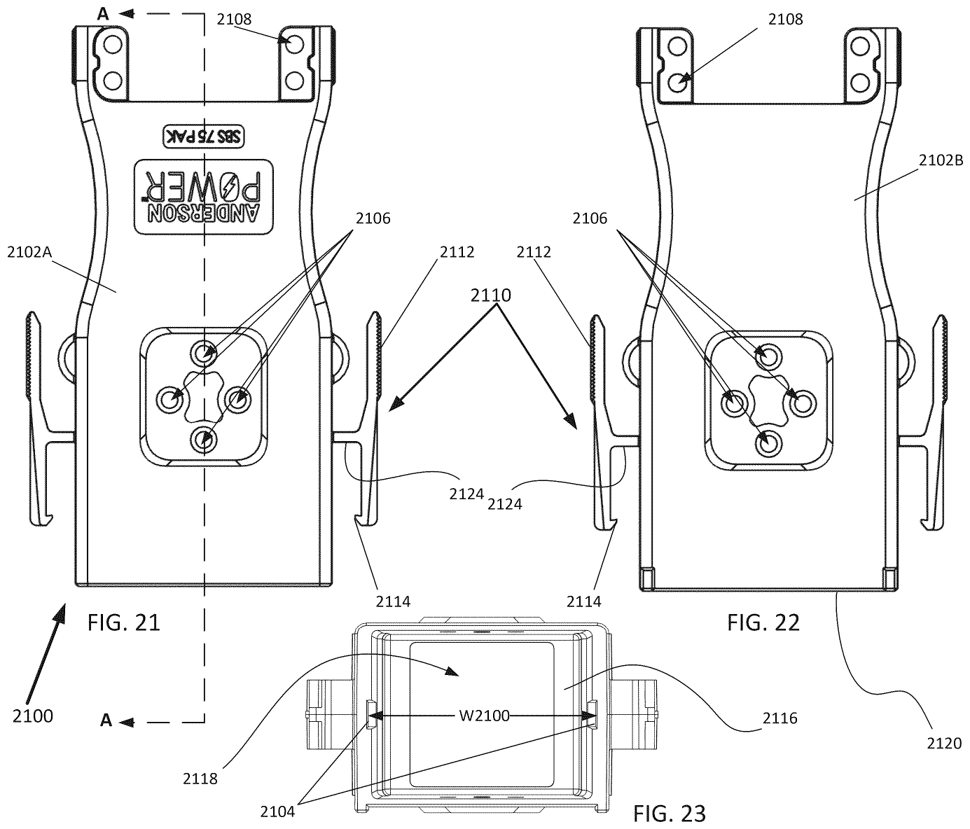

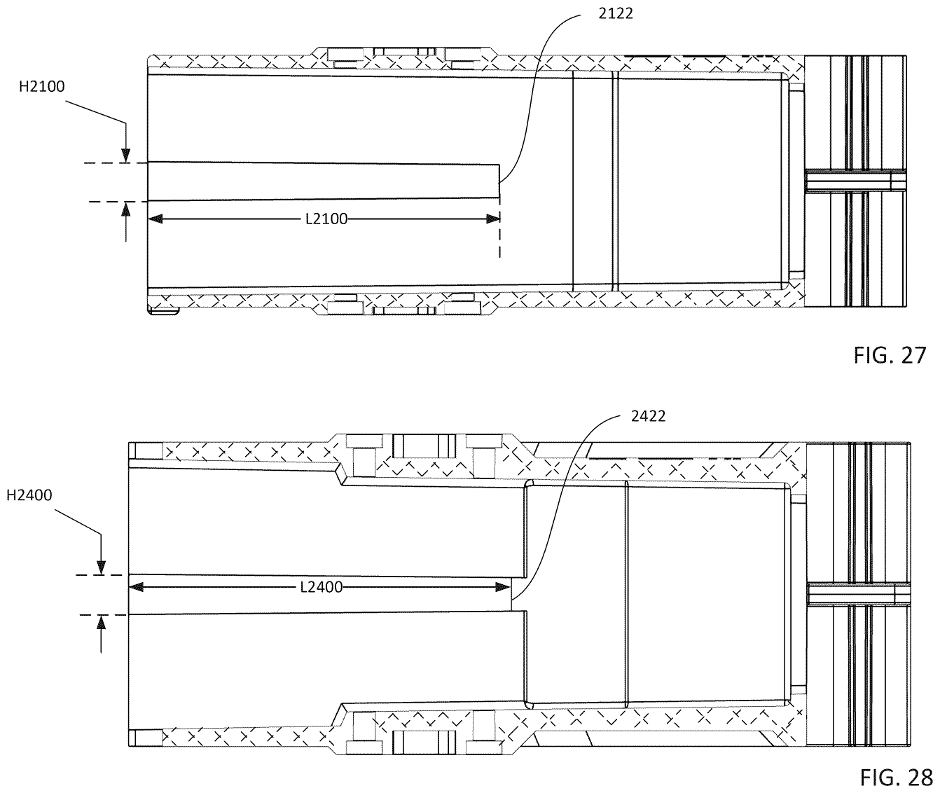

Referring again to FIG. 1, the first connector assembly 100 in the example embodiment further includes a connector housing 2100. The housing 2100 is shown in greater detail in FIGS. 21-23 and 27. In the example embodiment, the connector housing 2100 comprises a plurality of sides 2102A, 2102B which join together mechanically, chemically, or otherwise to form an outer surface 2102, an inner surface 2116, and an inner compartment 2118. The connector housing 2100 additionally defines a longitudinal slot 2104 that is configured to slidably receive the mounting plate 300 in an orientation with the assembly protrusions facing the open end 2120 of the connector housing 2100. The connector housing 2100 further contains at least one fastener aperture 2106 on at least one side 2102A, 2102B of the outer surface 2102, and in the example embodiment shown, the connector housing contains four fastener apertures 2106A on a first side 2102A of the connector housing 2100, arranged in a pattern, and four fastener 2106B apertures on a second side 2102B of the connector housing 2100, arranged in a pattern, substantially opposite the first side 2102A of the connector housing 2100.

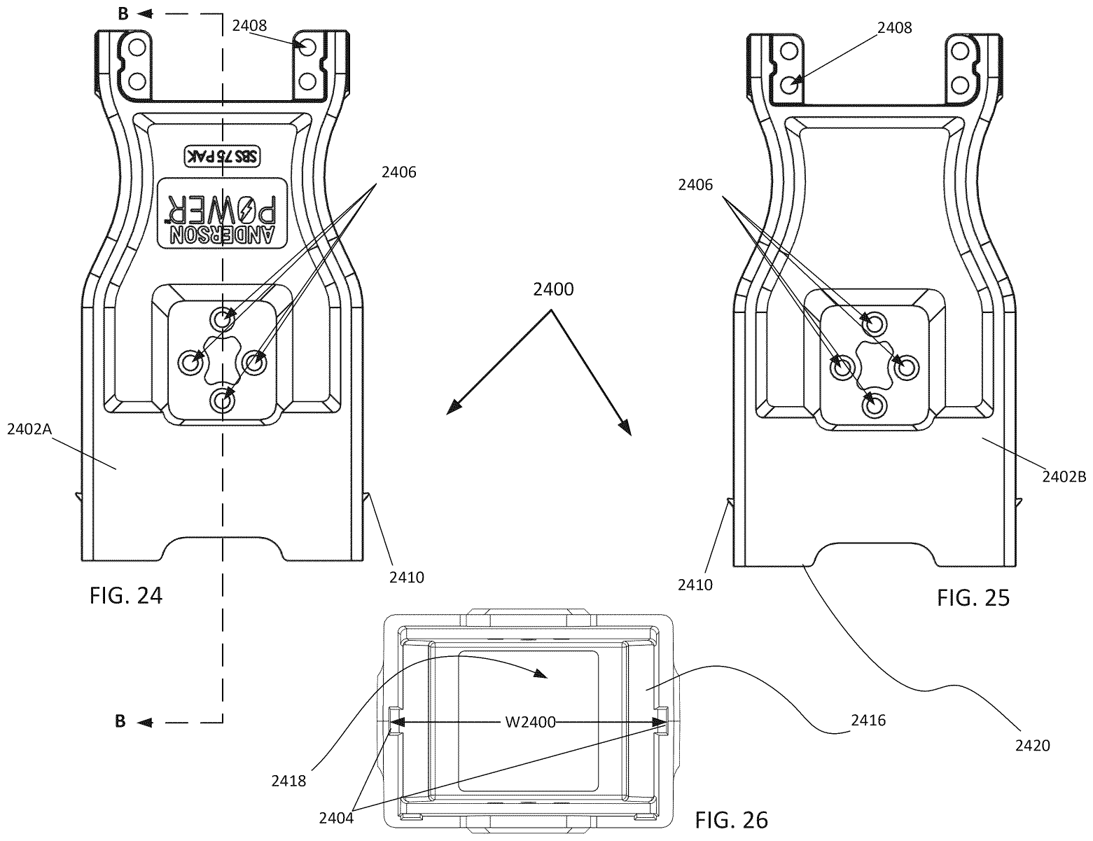

Referring again to FIG. 2, the second connector assembly 200 may further include a connector housing 2400. The housing is shown in greater detail in FIGS. 24-26 and 28. In the example embodiment, the connector housing comprises a plurality of sides 2402A, 2402B which join together mechanically, chemically, or otherwise to form an outer surface 2402, an inner surface 2416, and an inner compartment 2418. The connector housing additionally defines a longitudinal slot 2404 that is configured to slidably receive the mounting plate 1200 in an orientation with the assembly protrusions facing the open end 2420 of the connector housing 2400. The connector housing 2400 further contains at least one fastener aperture 2406 on at least one side 2402A, 2402B of the outer surface 2402, and in the example embodiment shown, the connector housing 2400 contains four fastener apertures 2406A on a first side 2402A of the connector housing 2400, arranged in a pattern, and four fastener apertures 2406B on a second side 2402B of the connector housing 2400, arranged in a pattern, substantially opposite the first side 2402A of the connector housing 2400.

The slot 2104, 2404 defined in each connector housing 2100, 2400 is designed to slidably—by press fit, by adhesive, by snap fit, or by other mechanical or chemical means—receive the mounting plate 300, 1200. As shown in FIGS. 6, 15, 23, 26, 27, and 28, the connector housings 2100, 2400 contain respective slots 2104, 2404 with a defined opening height H2100, H2400, a defined width W2100, W2400, and a defined depth L2100, L2400. The opening height H2100, H2400 of the connector housing 2100, 2400 slot 2104, 2404 may be configured to accept a mounting plate 300, 1200 of a certain thickness H300, H1200 by either press fit (interference fit) or by friction or sliding fit (closely tolerance gaps in the fit). Likewise, the spacing W2100, W2400 between the slots 2104, 2404 in the connector housing 2100, 2400 may be designed to affect the fit of the mounting plate 300, 1200 into the slot, where the mounting plate 300, 1200 likewise has a defined width W300, W1200, the spacing between walls of the slots 2104, 2404 may be adjusted to adjust the fit of the mounting plate 300, 1200 into the connector housing 2100, 2400. The connector housing 2100, 2400 slot 2104, 2404 may also have a defined depth L2100, L2400, which may be defined by a back wall 2122, 2422 of the slot, and which may close off the spacing distance W2100, W2400 between walls of the slot, and control the distance a mounting plate 300, 1200 may be inserted into the connector housing 2100, 2400 slot 2104, 2404 until the mounting plate 300, 1200 can no longer be pushed into the slot 2104, 2404 of the connector housing 2100, 2400.

Referring again to FIGS. 1-2, 3-7, and 12-16, the width W300, W1200, height H300, H1200, and depth L300, L1200 of the mounting plate 300, 1200 may be selected according to whether the mounting plate 300, 1200 contains mounting geometry 304, 1210 for a receptacle side of an electrical connector 1000, 1700, or a plug side of an electrical connector 800, 1900. In the example embodiment, a first mounting plate 300 may have a shorter width W300 than the width W1200 of a second mounting plate 1200 and also have a larger height H300. Thus, a user may only be able to insert the correct first mounting plate 300 into the proper plug side connector housing 2100, as the shortened width of the first mounting plate 300 will be too short to engage with the slots 2404 of the receptacle side connector housing 2400. Additionally, the first mounting plate 300 will have too great a height H300 to fit into the slots of the receptacle side connector housing 2400. Likewise, a second mounting plate 1200, in this same example, would have too great a width W1200 to fit into plug side connector housing 2100. Although this is just one embodiment, other embodiments may be configured so that either housing 2100, 2400 may be configured to receive either a first or second mounting plate 300, 1200. In other embodiments, a change in geometry other than a change in mounting plate 300, 1200 width W300, W1200 or height H300, H1200 may be used to differentiate between fitment into a connector housing 2100, 2400. In other embodiments, there is no difference in geometry between first or second mounting plates 300, 1200 and either mounting plate 300, 1200 may fit into either or both of a plug side connector housing 2100 or a receptacle side connector housing 2400.

The connector housing or the mounting plate may further or alternatively contain clip features or recessed features, pin or detent features, or adhesive features which all may be used to insert and fix or otherwise constrain the mounting plate inside of the connector housing. Any mechanical or chemical fixturing methods may be used in the same manner to achieve the same result of fixing or constraining the mounting plate inside of a connector housing.

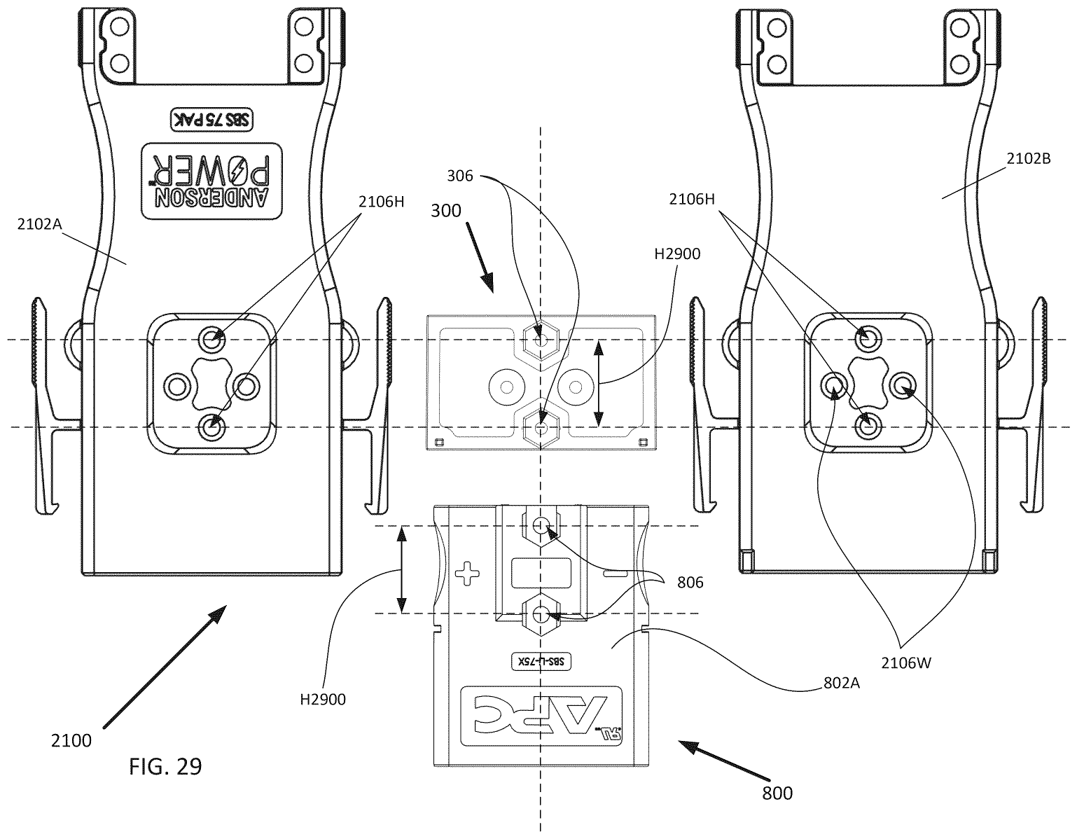

The connector housing 2100 further contains fastener apertures 2106 arranged in a pattern. Referring to FIG. 29, in which the dimensional relationships of the housing 2100 (top view at left; bottom view at right), mounting plate 300, and connector 800 are illustrated, at least one side of the connector housing 2100 may include a plurality of fastener apertures 2106. In the example embodiments shown, both a first surface 2102A and a second surface 2102B of the connector housing 2100 have four fastener apertures 2106. In the example embodiment, both the first side 2102A and second side 2102B of the connector housing 2100 have a first pair of fastener apertures 2106H aligned in a vertical spacing H2900. The fastener apertures 2106H aligned in a vertical spacing correspond to and align with a pattern or configuration of fastener apertures 806 on a connector 800. The fastener apertures 2106H having the vertical spacing H2900 are configured such that, when a mounting plate 300 is inserted in a proper orientation and fully seated against the back wall 2122 of the slot 2104 of the connector housing 2100, the fastener apertures 306 of the mounting plate 300, which align with the fastener apertures 806 of the connector 800, likewise also align with the fastener apertures 2106H aligned in a vertical spacing H2900 on either or both of the first side 2102A and second side 2102B of the connector housing 2100.

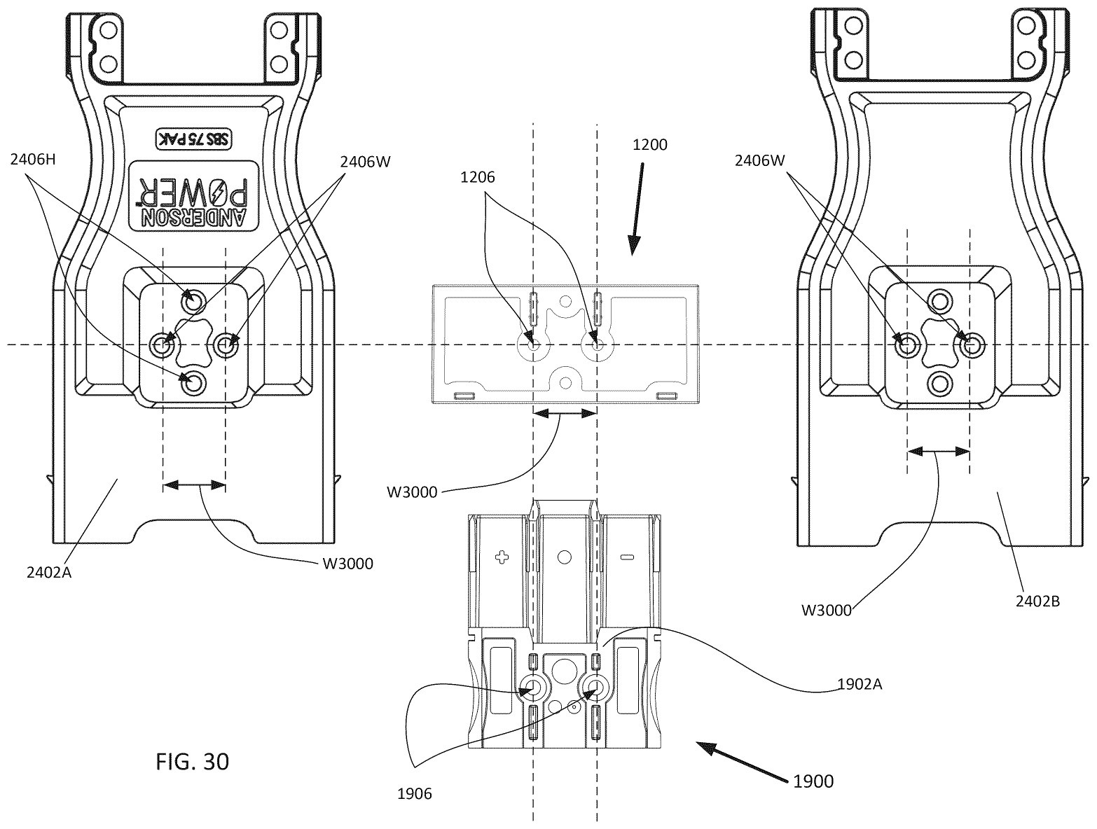

As shown in FIG. 30, in which the dimensional relationships of the housing 2400 (top view at left; bottom view at right), mounting plate 1200, and connector 1900 are illustrated, the first surface 2402A and the second surface 2402B of the connector housing 2400 have a second pair of fastener apertures 2406W aligned in a horizontal spacing W3000. The fastener apertures 2406W aligned in a horizontal spacing W30000 correspond to and align with a pattern or configuration of fastener apertures 1906 on a connector 1900. The fastener apertures 2406W having the horizontal spacing W30000 are configured such that, when a mounting plate 1200 is inserted in a proper orientation and fully seated against the back wall 2422 of the slot 2404 of the connector housing 2400, the fastener apertures 1206 of the mounting plate 1200, which align with the fastener apertures 1906 of the connector 1900, likewise also align with the fastener apertures 2406W aligned in a horizontal spacing W3000 on either or both of the first side 2402A and second side 2402B of the connector housing 2400.

As shown in FIGS. 1-2 and 29-30, in example embodiments, the electrical connectors of a first and second type 800, 1000, 1700, 1900 when installed on the mounting plate 300, 1200 may obscure either of the first pair 2106H, 2406H, or second pair 2106W, 2406W of fastener apertures 2106, 2406 on the mounting plate 300, 1200, such that the obscured pair of fastener apertures 2106, 2406 cannot be populated by a fastener 102 from the side of the mounting plate 300, 1200 having the electrical connector of a first or second type 800, 1000, 1700, 1900. In the example embodiment, the connector housing 2100, 2400 contains a first side 2102A, 2402A and a second side 2102B, 2402B which both contain both a first pair 2106H, 2406H and a second pair 2106W, 2406W of fastener apertures which are substantially opposite one another, and substantially mirrored, with the slot 2104, 2404 being the midplane of the mirror image. Thus, even when a mounting plate 300, 1200 is inserted into a the connector housing 2100, 2400 the mounting plate 300, 1200 having an electrical connector 800, 1000, 1700, 1900 installed on it and obscuring one of the two pairs of fastener apertures 2106, 2406, the other of the two pairs of fastener apertures will not be obscured, and the fastener apertures 306, 1206 of the mounting plate 300, 1200 which align with the fastener apertures 806, 1006, 1706, 1906 of the electrical connector 800, 1000, 1700, 1900, will also align with the fastener apertures 2106, 2406 of the connector housing 2100, 2400 no matter if the mounting plate 300, 1200 is installed with the electrical connector 800, 1000, 1700, 1900 facing the first side 2102A, 2402A or second side 2102B, 2402B of the connector housing 2100, 2400.

In some embodiments, the electrical connectors may only have one fastener aperture, with the fastener aperture being in a different position on a plug connector and receptacle connector. In such embodiments, the mounting plate and connector housing may contain both the fastener aperture locations of the plug connector and receptacle connector. The connector housing may contain the locations of the fastener apertures for the electrical connectors on a first side, and on a second side substantially mirrored about the slot of the connector housing. In some embodiments, electrical connectors may have more than two fastener apertures in different positions. In those embodiments, the mounting plate may contain the corresponding number and orientation of fastener apertures of the electrical connectors having more than two fastener apertures. The connector housing may also contain the corresponding number of fastener apertures for both types of electrical connectors having more than two fastener apertures on a first side, and may contain the corresponding number of fastener apertures on a second side mirrored about the slot, such that the mounting plate may be installed with either electrical connector facing the first side of the connector housing—the connector housing will have fastener apertures which align with the fastener apertures of that electrical connector.

In this same manner, an electrical connector housing and a mounting plate may be provided for more than two different types of electrical connectors having different mounting geometries and having different numbers and orientations of fastener apertures. It should be known that mounting plates may be provided with corresponding fastener aperture configurations, and connector housings may be provided with corresponding fastener aperture configurations on a first side of the connector housing, and on a second side of the connector housing mirrored about the slot, to accommodate any plurality of different electrical connectors.

The connector housing may be made from any appropriate material, including but not limited to plastics, composite, organic, metal alloys, or the like. The connector housing may also be manufactured using any appropriate method, including but not limited to machining, molding, injection molding, casting, or the like.

As shown in FIGS. 1-2, where electrical connectors may further comprise a plug side and a receptacle side, either connector housing may contain either house plug side connectors or receptacle side connectors, or a combination of plug side and receptacle side connectors. Two connector assemblies may be provided, one connector assembly housing at least one plug side connector, and another connector assembly housing at least one receptacle side connector.

Referring again to FIGS. 1 and 2, the plug (first) connector housing 2100 may be supplied in a connector assembly 100. The first connector housing 2100 may further be configured to fit inside of or be inserted into a receptacle (second) connector housing 2400. This can be achieved by dimensioning the connection interfacing side of the first or plug connector housing 2120 to be slightly smaller than the opening on the connection interfacing side of the second or receptacle connector housing 2420. The dimensions may be adjusted such that the plug connector housing 2100 may be slip fit into the receptacle connector housing 2400, transition fit, or press fit (interference fit). Any mechanical or chemical means of fitting the two connector housings together may accomplish the same result of securing the electrical connectors together, in much the same way.

Additionally, as mechanical vibrations, movement, or other external forces may work to pull apart the connector housings 2100, 2400 and thus interrupt the electrical connection, additional securing features may be provided on the connector housings 2100, 2400. Shown in FIGS. 21-26, for example, the connector housings 2100, 2400 may further contain fastener apertures 2108, 2408, where a user may be able to drive fasteners through the fastener apertures 2108, 2408 to secure the connector housing 2100, 2400 to a surface. Additionally, the plug connector housing 2100 may have a clip 2110 that fits into a recess feature 2410 of the receptacle connector housing 2400. The clip 2110 may be made integral to the connector housing or may be manufactured separately and mechanically fastened to the connector housing 2100.

In the embodiment of FIGS. 1 and 21-23, the plug connector housing 2100 contains a clip feature 2110 that is integral to the connector housing 2100. The clip feature 2110 contains a press surface 2112, a retention feature 2114, and a deflection member 2124. A user may press on the press surface 2112, which is cantilevered about the deflection member 2124, opposite the retention feature 2114. When a user presses on the press feature 2112, the deflection member 2124 may bend, moving the retention feature away from the body of the first connector housing 2100. The user may then insert the plug connector housing 2100 inside of the receptacle connector housing 2400 and release the press surface of the clip 2112 which returns the retention feature 2114 to its resting position. In the embodiment shown in FIGS. 2 and 24-26, the receptacle connector housing 2400 may contain a recess feature 2410 into which the retention feature 2114 of the clip 2110 fits into in the clip resting position.

Although certain embodiments of the clip 2110 and recess 2410 features may be shown, some similar embodiments may accomplish the same result of securing a plug connector housing to a receptacle connector housing by functioning in the same way. Examples of other embodiments include using mechanical fasteners, using a clip that utilizes a spring and lever that pivots, using spring pin and detents, using mechanical latches, and other fastening methods that contain similar structure and operate in the same way.

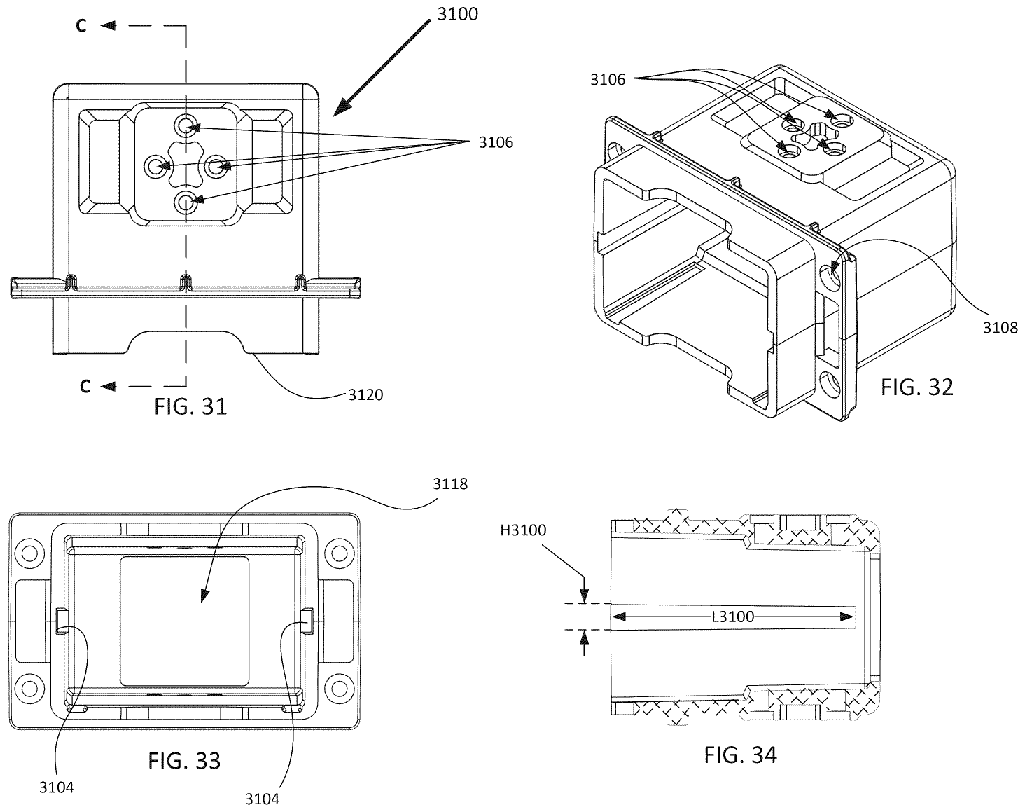

FIGS. 31-34 illustrate a connector housing that enables provision of a multi-connector assembly as a stationary outlet. The connector housing 3100 may include a slot 3104 and fastener apertures 3106 largely the same as previous connector housings. However, instead of containing features for maintaining a connection to another connector housing, the connector housing 3100 contains fastener apertures 3106 that are on a substantially parallel plane to the connection interfacing side 3120 of the connector housing 3100. In this embodiment, the connector housing 3100 may connect to a surface outlet, and then be secured by driving fasteners through the fastener apertures 3106 of the connector housing 3100 securing the connector housing 3100 to a surface.

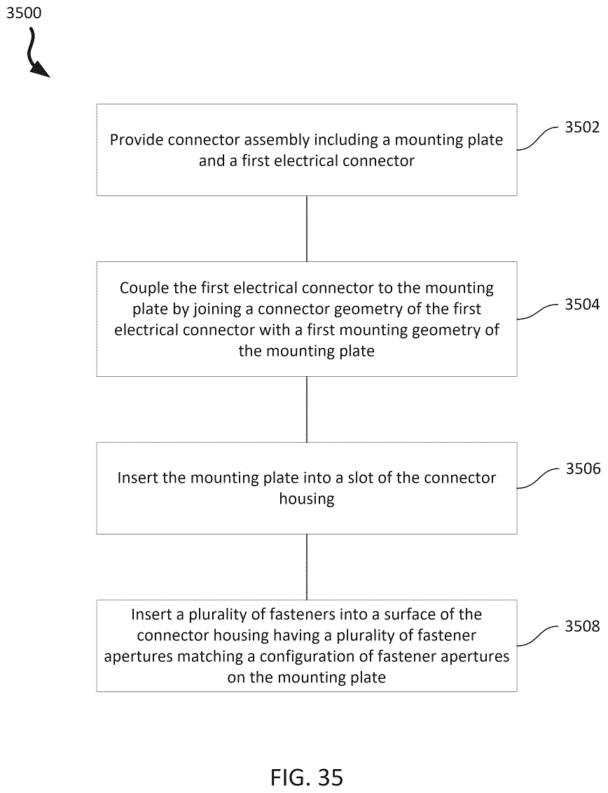

FIG. 35 is a flow chart illustrating an example method for assembling a connector assembly. The method may be performed to assembly, for example, the assemblies of either of FIG. 1 or FIG. 2.

The method 3500 may include, at block 3502, providing a connector assembly. The connector assembly may include a mounting plate defining a first mounting geometry configured to mate with a first electrical connector and a first plurality of fastener apertures configured in a pattern. The connector assembly may further include a connector housing configured to secure the electrical connector. The connector housing may include a first surface defining a second plurality of fastener apertures configured in the pattern, a second surface defining a third plurality of fastener apertures configured in the pattern, and a slot shaped to receive the mounting plate and to hold the mounting plate in a substantially fixed position in which the first plurality of fastener apertures aligns with one or both of the second plurality of fastener apertures or the third plurality of fastener apertures.

In an example of block 3502, a user may first select a first plug connector. The user may then retrieve a mounting plate with mounting geometry on a first side that corresponds to the mounting geometry of the plug connector.

The method 3500 may further include, at block 3504, coupling the first electrical connector to the mounting plate by joining a connector geometry of the first electrical connector with the first mounting geometry. For example, a user may place a first side of the plug connector on a first side of the mounting plate in a proper orientation as indicated by the protrusions on the mounting plate. The user may then select a receptacle connector. The user may then place a first side of the receptacle connector on a second side of the mounting plate that corresponds to the mounting geometry of the receptacle connector in a proper orientation as indicated by the protrusions on the mounting plate.

The method 3500 may further include, at block 3506, inserting the mounting plate into the connector housing slot, the first electrical connector facing either of the first or second surface of the connector housing. For example, a user may then insert the mounting plate into a first connector housing containing clip features in either of two orientations with the protrusions on the mounting plate closest to the connection interfacing side of the first connector housing. The user may insert the mounting plate until the mounting plate is fully seated within the connector housing as indicated when the mounting plate is stopped by the back wall of the slot of the connector housing.

The method 3500 may further include, at block 3508, inserting a plurality of fasteners into the either of the first or second surface of the connector housing having the plurality of fastener apertures matching the configuration of fastener apertures on the mounting plate. For example, a user may drive fasteners into first the either of a first or second pair of fastener apertures on the first side of the first connector housing which correspond to the fastener apertures of the electrical connector of the type that is facing the first side of the first connector housing. The user may then drive fasteners into the other of the first or second pair of fastener apertures on the second side of the first connector housing which correspond to the fastener apertures of the electrical connector of the type that is facing the second side of the first connector housing.

The method 3500 may be repeated to assemble a second connector assembly. For example, the user may repeat the method as described above, this time with a second connector housing containing recess features and mounting each of the electrical connectors of a first and second type on the second side of each connector to a mounting plate with mounting geometry corresponding to the second side of each of the electrical connector of a first and second type.

Having secured the connectors to the second connector housing containing recess features, the user may then insert the first (plug) connector housing into the second (receptacle) connector housing while depressing the press feature of the clip on the first connector housing. Once the connection interfacing side of the first connector housing is inserted into the connection interfacing side of the second connector housing, the user may release the press feature of the first connector housing allowing the retention feature of the clip on the first connector housing to engage with the recess features on the second connector housing. In this manner, the user has made an electrical connection with connectors of type different types that is positively engaged and may be able to withstand external forces acting on the electrical connectors.

The systems and methods described herein offer multiple benefits to electrical connectors and electrical connector assemblies. Providing an assembly for different electrical connectors increases the efficiency of making electrical connections requiring multiple conductive elements. Providing a mounting plate to secure electrical connectors to, and a connector housing to insert the mounting plate and connector into helps avoid incorrect positioning and assembly of different electrical connectors. Providing an assembly for electrical connectors also increases the reliability and durability of the electrical connections and shields the connectors themselves from debris and damage from external elements.

In a first aspect of the present disclosure, an electrical connector assembly is provided that includes a mounting plate defining a mounting geometry configured to mate with an electrical connector, and a first plurality of fastener apertures configured in a pattern. The assembly further includes a connector housing configured to secure the electrical connector, the connector housing including a first surface defining a second plurality of fastener apertures configured in the pattern, a second surface defining a third plurality of fastener apertures configured in the pattern, and a slot shaped to receive the mounting plate and to hold the mounting plate in a substantially fixed position in which the first plurality of fastener apertures aligns with one or both of the second plurality of fastener apertures or the third plurality of fastener apertures.

In an embodiment of the first aspect, the mounting geometry includes at least one of a protrusion configured to mate with a recess on the electrical connector, or a recess configured to mate with a protrusion on the electrical connector.

In an embodiment of the first aspect, the electrical connector is a first electrical connector, the mounting geometry is a first mounting geometry and is defined on a first side of the mounting plate, and a second side of the mounting plate defines a second mounting geometry configured to mate with a second electrical connector. In a further embodiment of the first aspect, the first mounting geometry includes at least one of a protrusion configured to mate with a recess on the first electrical connector, or a recess configured to mate with a protrusion on the first electrical connector, and the second mounting geometry includes at least one of a protrusion configured to mate with a recess on the second electrical connector, or a recess configured to mate with a protrusion on the second electrical connector.

In an embodiment of the first aspect, the electrical connector is a first electrical connector, the mounting geometry is a first mounting geometry and is defined on a first side of the mounting plate, and a second side of the mounting plate defines a second mounting geometry configured to mate with either of the first electrical connector or a second electrical connector.

In an embodiment of the first aspect, the pattern is a first pattern, the mounting plate further defines a fourth plurality of fastener apertures configured in a second pattern, and the first plurality of fastener apertures defining a first pattern and a fourth plurality of fastener apertures defining a second pattern on the mounting plate align with one or both of the second plurality of fastener apertures or the third plurality of fastener apertures of the connector housing.

In an embodiment of the first aspect, the mounting plate comprises a terminal side, the terminal side further defining at least one protrusion, and the protrusion is configured to indicate the terminal side of the mounting plate, further mount the electrical connector in a correct orientation; and prevent incorrect positions of the mounting plate inside the connector housing.

In an embodiment of the first aspect, the connector housing further includes one of a clip or a clipping recess to secure the connector housing to a second connector housing. In a further embodiment of the first aspect, the mounting plate is a first mounting plate, the connector housing is a first connector housing, and the assembly further includes a second mounting plate and the second connector housing, wherein the second connector housing is configured to receive the second mounting plate and one or more electrical connectors coupled to the second mounting plate, the second connector housing comprising one of a clipping recess configured to couple with the clip of the first connector housing or a clip to couple with the clipping recess of the first connector housing.

In a second aspect of the present disclosure, an electrical connector assembly is provided that includes a mounting plate including a first side defining a first mounting geometry configured to mate with a first electrical connector and a second side defining a second mounting geometry configured to mate with a second electrical connector, wherein the mounting plate defines a first plurality of fastener apertures configured in a pattern. The electrical connector further includes a connector housing configured to secure the first electrical connector and second electrical connector, the connector housing including a first surface defining a second plurality of fastener apertures configured in the pattern, a second surface defining a third plurality of fastener apertures configured in the pattern, and a slot shaped to receive the mounting plate and to hold the mounting plate in a substantially fixed position in which the first plurality of fastener apertures aligns with one or both of the second plurality of fastener apertures or the third plurality of fastener apertures.

In an embodiment of the second aspect, the first mounting geometry includes at least one of a protrusion configured to mate with a recess on the first electrical connector, or a recess configured to mate with a protrusion on the first electrical connector, and the second mounting geometry includes at least one of a protrusion configured to mate with a recess on the second electrical connector, or a recess configured to mate with a protrusion on the second electrical connector.

In an embodiment of the second aspect, the mounting plate further defines a terminal side, the terminal side further defining at least one protrusion, and the protrusion is configured to indicate the terminal side of the mounting plate, further mount the electrical connector in a correct orientation; and prevent incorrect positions of the mounting plate inside the connector housing.

In an embodiment of the second aspect, the connector housing further includes one of a clip or a clipping recess to secure the connector housing to a second connector housing. In a further embodiment of the second aspect, the mounting plate is a first mounting plate, the assembly further including a second mounting plate and the second connector housing configured to receive the second mounting plate and one or more electrical connectors coupled to the second mounting plate, the second connector housing including a clipping recess configured to couple with one of the clip of the first connector housing or a clip to couple with the clipping recess of the first connector housing. In a further embodiment of the second aspect, a first side of the second mounting plate includes geometry configured to mate with either of the first electrical connector or the second electrical connector, and a second side of the second mounting plate includes geometry configured to mate with the other of the first electrical connector or the second electrical connector.

In a third aspect of the present disclosure, a method for assembling a connector assembly is provided, the method including providing a connector assembly, the connector assembly including a mounting plate defining a first mounting geometry configured to mate with a first electrical connector, a first plurality of fastener apertures configured in a pattern, and a connector housing configured to secure the electrical connector, the connector housing including a first surface defining a second plurality of fastener apertures configured in the pattern, a second surface defining a third plurality of fastener apertures configured in the pattern, and a slot shaped to receive the mounting plate and to hold the mounting plate in a substantially fixed position in which the first plurality of fastener apertures aligns with one or both of the second plurality of fastener apertures or the third plurality of fastener apertures. The method further includes coupling the first electrical connector to the mounting plate by joining a connector geometry of the first electrical connector with the first mounting geometry, inserting the mounting plate into the connector housing slot, the first electrical connector facing either of the first or second surface of the connector housing, and inserting a plurality of fasteners into the either of the first or second surface of the connector housing having the plurality of fastener apertures matching the configuration of fastener apertures on the mounting plate.

In an embodiment of the third aspect, the mounting geometry is a first mounting geometry and is defined on a first side of the mounting plate, and a second side of the mounting plate defines a second mounting geometry configured to mate with a second electrical connector.

In an embodiment of the third aspect, wherein before inserting the mounting plate into the connector housing slot, the method further includes placing the second electrical connector having a second geometry on the mounting plate second mounting geometry.

In an embodiment of the third aspect, the connector housing is a first connector housing and further includes one of a clip or a clipping recess to secure the first connector housing to a second connector housing, and the mounting plate is a first mounting plate, the assembly further including a second mounting plate, where the second connector housing is configured to receive the second mounting plate and one or more electrical connectors coupled to the second mounting plate, the second connector housing including one of a clipping recess configured to couple with the clip of the first connector housing or a clip to couple with the clipping recess of the first connector housing. In a further embodiment of the third aspect, the method further includes placing a second electrical connector having a first geometry on the second mounting plate first mounting geometry, inserting the second mounting plate into the second connector housing slot, the connector of a first type facing either of the first or second surface of the second connector housing, inserting a plurality of fasteners into the either of the first or second surface of the second connector housing having the plurality of fastener apertures matching the configuration of fastener apertures on the mounting plate, and connecting the first connector housing to the second connector housing by placing the clip of one of the either first connector housing or second connector housing into the clipping recess of the other of the first connector housing or second connector housing.

Example methods and systems are described above. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the above detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated figures, can be arranged, substituted, combined, separated, and designed in a wide variety of different configurations, all of which are explicitly contemplated herein.

While various aspects and embodiments have been disclosed herein, some aspects and embodiments will be apparent to those skilled in the art. The various aspects and embodiments disclosed herein are for purposes of illustration and are not intended to be limiting, with the true scope and spirit being indicated by the following claims. Some embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. An electrical connector assembly comprising:
a mounting plate defining:
a mounting geometry configured to mate with an electrical connector; and
a first plurality of fastener apertures configured in a pattern; and
a connector housing configured to secure the electrical connector, the connector housing comprising:
a first surface defining a second plurality of fastener apertures configured in the pattern;
a second surface defining a third plurality of fastener apertures configured in the pattern; and
a slot shaped to receive the mounting plate and to hold the mounting plate in a substantially fixed position in which the first plurality of fastener apertures aligns with one or both of the second plurality of fastener apertures or the third plurality of fastener apertures.

2. The connector assembly of claim 1, wherein the mounting geometry comprises at least one of:
a protrusion configured to mate with a recess on the electrical connector; or
a recess configured to mate with a protrusion on the electrical connector.

3. The connector assembly of claim 1, wherein:
the electrical connector is a first electrical connector;
the mounting geometry is a first mounting geometry and is defined on a first side of the mounting plate; and
a second side of the mounting plate defines a second mounting geometry configured to mate with a second electrical connector.

4. The connector assembly of claim 3, wherein:
the first mounting geometry comprises at least one of:
a protrusion configured to mate with a recess on the first electrical connector; or
a recess configured to mate with a protrusion on the first electrical connector; and
the second mounting geometry comprises at least one of:
a protrusion configured to mate with a recess on the second electrical connector; or
a recess configured to mate with a protrusion on the second electrical connector.

5. The connector assembly of claim 1, wherein:
the electrical connector is a first electrical connector;
the mounting geometry is a first mounting geometry and is defined on a first side of the mounting plate; and
a second side of the mounting plate defines a second mounting geometry configured to mate with either of the first electrical connector or a second electrical connector.

6. The connector assembly of claim 1, wherein:
the pattern is a first pattern;
the mounting plate further defines a fourth plurality of fastener apertures configured in a second pattern; and
the first plurality of fastener apertures defining a first pattern and a fourth plurality of fastener apertures defining a second pattern on the mounting plate align with one or both of the second plurality of fastener apertures or the third plurality of fastener apertures of the connector housing.

7. The connector assembly of claim 1, wherein:
the mounting plate comprises a terminal side, the terminal side further defining at least one protrusion; and
the protrusion is configured to indicate the terminal side of the mounting plate, further mount the electrical connector in a correct orientation; and prevent incorrect positions of the mounting plate inside the connector housing.

8. The connector assembly of claim 1, wherein the connector housing further comprises one of a clip or a clipping recess to secure the connector housing to a second connector housing.

9. The connector assembly of claim 8, wherein the mounting plate is a first mounting plate, the connector housing is a first connector housing, the assembly further comprising:
a second mounting plate; and
the second connector housing;
wherein the second connector housing is configured to receive the second mounting plate and one or more electrical connectors coupled to the second mounting plate, the second connector housing comprising one of a clipping recess configured to couple with the clip of the first connector housing or a clip to couple with the clipping recess of the first connector housing.

10. An electrical connector assembly comprising:
a mounting plate comprising:
a first side defining a first mounting geometry configured to mate with a first electrical connector; and
a second side defining a second mounting geometry configured to mate with a second electrical connector;
wherein the mounting plate defines a first plurality of fastener apertures configured in a pattern; and
a connector housing configured to secure the first electrical connector and second electrical connector, the connector housing comprising:
a first surface defining a second plurality of fastener apertures configured in the pattern;
a second surface defining a third plurality of fastener apertures configured in the pattern; and
a slot shaped to receive the mounting plate and to hold the mounting plate in a substantially fixed position in which the first plurality of fastener apertures aligns with one or both of the second plurality of fastener apertures or the third plurality of fastener apertures.

11. The connector assembly of claim 10, wherein:
the first mounting geometry comprises at least one of:
a protrusion configured to mate with a recess on the first electrical connector; or
a recess configured to mate with a protrusion on the first electrical connector; and
the second mounting geometry comprises at least one of:
a protrusion configured to mate with a recess on the second electrical connector; or
a recess configured to mate with a protrusion on the second electrical connector.

12. The connector assembly of claim 10, wherein:
the mounting plate further defines a terminal side, the terminal side further defining at least one protrusion; and
the protrusion is configured to indicate the terminal side of the mounting plate, further mount the electrical connector in a correct orientation; and prevent incorrect positions of the mounting plate inside the connector housing.

13. The connector assembly of claim 10, wherein the connector housing further comprises one of a clip or a clipping recess to secure the connector housing to a second connector housing.

14. The connector assembly of claim 13 wherein the mounting plate is a first mounting plate, the assembly further comprising:
a second mounting plate; and
the second connector housing configured to receive the second mounting plate and one or more electrical connectors coupled to the second mounting plate, the second connector housing comprising a clipping recess configured to couple with one of the clip of the first connector housing or a clip to couple with the clipping recess of the first connector housing.

15. The connector assembly of claim 14 wherein:
a first side of the second mounting plate comprises geometry configured to mate with either of the first electrical connector or the second electrical connector; and
a second side of the second mounting plate comprises geometry configured to mate with the other of the first electrical connector or the second electrical connector.

16. A method for assembling a connector assembly, the method comprising:
providing a connector assembly, the connector assembly comprising:
a mounting plate defining:
a first mounting geometry configured to mate with a first electrical connector; and
a first plurality of fastener apertures configured in a pattern; and
a connector housing configured to secure the electrical connector, the connector housing comprising:
a first surface defining a second plurality of fastener apertures configured in the pattern;
a second surface defining a third plurality of fastener apertures configured in the pattern; and
a slot shaped to receive the mounting plate and to hold the mounting plate in a substantially fixed position in which the first plurality of fastener apertures aligns with one or both of the second plurality of fastener apertures or the third plurality of fastener apertures;
coupling the first electrical connector to the mounting plate by joining a connector geometry of the first electrical connector with the first mounting geometry;
inserting the mounting plate into the connector housing slot, the first electrical connector facing either of the first or second surface of the connector housing; and
inserting a plurality of fasteners into the either of the first or second surface of the connector housing having the plurality of fastener apertures matching the configuration of fastener apertures on the mounting plate.

17. The method of claim 16, wherein:
the mounting geometry is a first mounting geometry and is defined on a first side of the mounting plate; and
a second side of the mounting plate defines a second mounting geometry configured to mate with a second electrical connector.

18. The method of claim 17, wherein before inserting the mounting plate into the connector housing slot, the method further comprises:
placing the second electrical connector having a second geometry on the mounting plate second mounting geometry.

19. The method of claim 16, wherein:
the connector housing is a first connector housing and further comprises one of a clip or a clipping recess to secure the first connector housing to a second connector housing; and
the mounting plate is a first mounting plate, the assembly further comprising a second mounting plate;
the second connector housing configured to receive the second mounting plate and one or more electrical connectors coupled to the second mounting plate, the second connector housing comprising one of a clipping recess configured to couple with the clip of the first connector housing or a clip to couple with the clipping recess of the first connector housing.

20. The method of claim 19, wherein the method further comprises:
placing a second electrical connector having a first geometry on the second mounting plate first mounting geometry;
inserting the second mounting plate into the second connector housing slot, the connector of a first type facing either of the first or second surface of the second connector housing;
inserting a plurality of fasteners into the either of the first or second surface of the second connector housing having the plurality of fastener apertures matching the configuration of fastener apertures on the mounting plate; and
connecting the first connector housing to the second connector housing by placing the clip of one of the either first connector housing or second connector housing into the clipping recess of the other of the first connector housing or second connector housing.
